(19) United States
(12) Patent Application Publication
(10) Pub. No.: US 2025/0168608 A1
(43) Pub. Date: May 22, 2025

(54) DYNAMIC DIRECTION SWITCHING FOR BIDIRECTIONAL IN CAR COMMUNICATION (ICC) BASED ON TALKER ROW IDENTIFICATION

(71) Applicant: Analog Device International Unlimited Company, Limerick (IE)

(72) Inventors: Sudheer Babu, Therlam Mandal (IN); Deepak Raghotham, Bangalore (IN); Dietmar Ruwisch, Berlin (DE)

(21) Appl. No.: 18/957,240

(22) Filed: Nov. 22, 2024

(30) Foreign Application Priority Data
Nov. 22, 2023 (IN) 202341079218

(51) Int. Cl. H04W 4/48

(52) U.S. Cl. CPC H04W 4/48

(57) ABSTRACT

Aspects of the present disclosure are directed to dynamic direction switching for bi-directional in car communication based on talker row identification. In an aspect, a method of in-vehicle communication includes performing cross-correlation on audio signals received from a plurality of microphones in a plurality of seat rows of a vehicle to determine a seat row of the plurality of seat rows from which speech is originating from a loudest talker from among one or more talkers. In an aspect, the method further includes muting a first set of one or more loudspeakers in the seat row of the loudest talker. In an aspect, the method also includes stopping operation of one or more adaptive filters on one or more of the speech signals corresponding to one or more feedback paths originating from the one or more loudspeakers that are muted.

### CROSS-REFERENCE TO RELATED APPLICATIONS

The present application claims priority to India Provisional Patent Application 20/234,1079218, filed Nov. 22, 2023.

### TECHNICAL FIELD

Aspects of the present disclosure relate generally to in car communications and, more particularly, to dynamic direction switching for bidirectional in car communication (ICC) based on talker row identification.

### BACKGROUND

The objective of an in car communication (ICC) system is to facilitate effortless communication between a talker and listener seated in different rows of a (large) passenger vehicle. ICC is achieved using microphones, placed overhead, in the talker's row, to record speech and then render the speech, in real time, after reinforcement, on (existing) speakers in the listener's row. If reinforcement is to be provided along any one direction only, i.e., front row to rear row or rear row to front row, then unidirectional ICC is used, and is realized using a single microphone-speaker pair.

But, if reinforcement is to be provided along both directions simultaneously, then bidirectional ICC is used, and is realized using two microphone-speaker pairs; one microphone-speaker pair for each direction. However, having a microphone and a speaker in a closed loop causes what is called Larsen's effect, better known as howling (due to positive feedback). Being able to suppress howling (feedback suppression) while providing sufficient reinforcement is the technical challenge that any ICC system must solve.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

In an aspect, a method of in-vehicle communication is provided. The method includes performing cross-correlation on audio signals received from a plurality of microphones in a plurality of seat rows of a vehicle to determine a seat row of the plurality of seat rows from which speech is originating from a loudest talker from among one or more talkers. The method further includes muting a first set of one or more loudspeakers in the seat row of the loudest talker. The method also includes stopping operation of one or more adaptive filters on one or more of the speech signals corresponding to one or more feedback paths originating from the one or more loudspeakers that are muted.

In an aspect, an apparatus includes one or more memories. The apparatus further includes one or more processors coupled with the one or more memories, wherein the one or more processors are configured, individually or in combination, to: perform cross-correlation on audio signals received from a plurality of microphones in a plurality of seat rows of a vehicle to determine a seat row of the plurality of seat rows from which speech is originating from a loudest talker from among one or more talkers; mute a first set of one or more loudspeakers in the seat row of the loudest talker; and stop operation of one or more adaptive filters on one or more of the speech signals corresponding to one or more feedback paths originating from the one or more loudspeakers that are muted.

In an aspect, a computer-readable medium is provided having instructions stored thereon. The instructions are executable by one or more processors, individually or in combination, to perform a method. The method includes performing cross-correlation on audio signals received from a plurality of microphones in a plurality of seat rows of a vehicle to determine a seat row of the plurality of seat rows from which speech is originating from a loudest talker from among one or more talkers. The method further includes muting a first set of one or more loudspeakers in the seat row of the loudest talker. The method also includes stopping operation of one or more adaptive filters on one or more of the speech signals corresponding to one or more feedback paths originating from the one or more loudspeakers that are muted.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which.

FIG. 1 is a block diagram of an example vehicle with passengers, microphones, and speakers, in accordance with an exemplary aspect.

FIG. 2 is a block diagram of an example of unidirectional in car communications (ICC), in accordance with an exemplary aspect.

FIG. 3 is a block diagram of an example of bidirectional in car communications (ICC), in accordance with an exemplary aspect.

FIG. 4 is a block diagram of another example of bidirectional in car communications (ICC), in accordance with an exemplary aspect

FIG. 5 is a flow diagram of an example method for bidirectional in car communications (ICC) using cross-correlation, in accordance with an exemplary aspect

FIG. 6 is a flow diagram of another example method for bidirectional in car communications (ICC) using cross-correlation, in accordance with an exemplary aspect.

FIG. 7 is a high-level block diagram for bidirectional in car communications (ICC) using cross-correlation, in accordance with an exemplary aspect.

FIG. 8 is a plot of an unsmoothed lag cross-correlation estimate and a smoothed cross-correlation estimate, in accordance with an exemplary aspect.

FIGS. 9 and 10 are plots of the direction estimated using cross-correlation, in accordance with an exemplary aspect.

FIG. 11 is a block diagram of an example of a computer environment, in accordance with an exemplary aspect.

FIG. 12 is a flow diagram of an example method for bidirectional in car communications (ICC) using cross-correlation, in accordance with an exemplary aspect.

FIG. 13 is a flow diagram of further blocks of a block of FIG. 12, in accordance with an exemplary aspect.

FIG. 14 is a flow diagram of further blocks of the method of FIG. 12, in accordance with an exemplary aspect.

### DETAILED DESCRIPTION

The present disclosure addresses the problem of talker voice coupling into adjacent row microphone in bi-directional in-car-communication (ICC), in order to prevent the talker from hearing an amplified version of his/her own voice, from speakers on their own row.

The present disclosure has the added advantage of simplifying a bi-directional ICC system into two time-multiplexed unidirectional ICC systems, leading to greater system stability.

The objective of an ICC system is to facilitate effortless communication between a talker and listener seated in different rows of a (large) passenger vehicle.

ICC is achieved using microphones, placed overhead, in the talker's row, to record speech and then render the speech, in real time, after reinforcement, on (existing) speakers in the listener's row.

If reinforcement is to be provided along any one direction only, i.e., front row to rear row or rear row to front row, unidirectional ICC is used, and is realized using a single microphone-speaker pair.

However, if reinforcement is to be provided along both directions simultaneously, bidirectional ICC is used, and can be realized using two microphone-speaker pairs; one for each direction.

A problem that is observed in bi-directional communication, especially when established between adjacent rows in the vehicle, is that the microphone inputs speech originating from a row that it is not intended for being input. The result of this is that reinforced speech of the talker is rendered on the talker's own row in addition to the listener's row. This leads to the talker hearing an amplified version of his/her own voice, which can be perceived as unnatural and disturbing.

The present disclosure addresses this problem by determining which row speech is originating from and muting the speakers on that row.

The following is a description of one example method:

Step 1. Feedback suppression is applied on the individual microphone signals to remove feedback originating from the speakers and retain only direct path components originating from the talker.

Step 2. Cross-correlation is applied on the resultant signals of step 1 to estimate relative lag. If step 1 is not performed, lag corresponding to feedback components enters into the calculation, resulting in an incorrect estimate.

Step 3. Result of step 2 is smoothed to generate a steady lag estimate.

Step 4. To avoid incorrect lag estimates during no-speech periods, an energy threshold is imposed on the result of step 1, and lag estimates are treated as valid only when the threshold is exceeded.

Step 5. To avoid incorrect lag estimates, an upper and lower bound is imposed on the lag estimate, corresponding to the expected lag values based on microphone spacing. Lag values outside of these bounds are disregarded.

Step 6. The resultant lag signal after step 5 is used to decide which row speakers to mute.

An aspect of the present disclosure has an advantage of simplifying a bi-directional ICC system into two time multiplexed unidirectional ICC systems, leading to greater system stability.

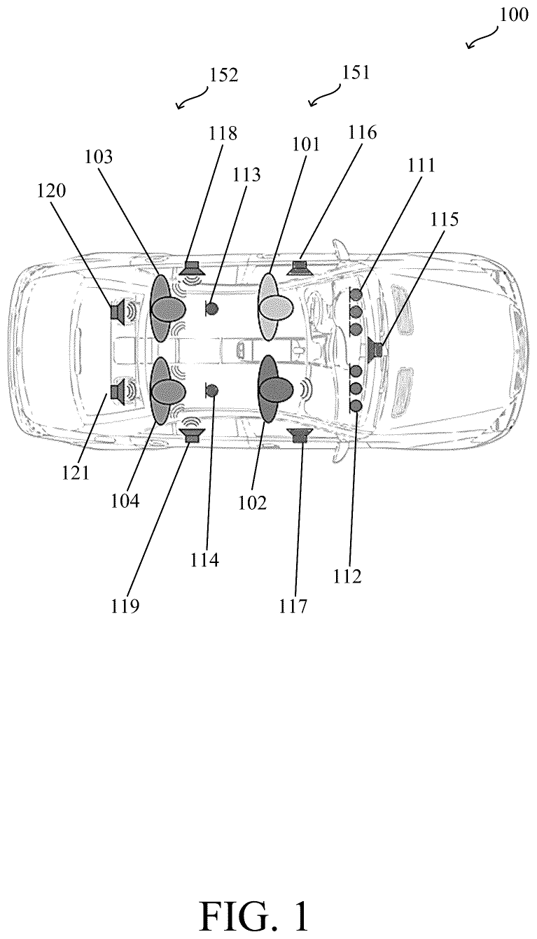

Referring to FIG. 1, an example vehicle 100 with passengers, microphones, and speakers is shown, in accordance with an exemplary aspect.

The vehicle 100 includes a front portion 151 with front driver 101 and passenger 102, and rear portion 152 with rear passengers 103 and 104.

In an aspect, microphones 111, 112 and speakers 118, 119, 120, and 121 are used for front to rear communication and microphones 113, 114 and speakers 115, 116, 117 are used for rear to front communication.

In an aspect, a single speaker and microphone pair is used for each row. Such an arrangement enables for economical bi-directional in car communication (ICC) based on talker row identification. In this way, the number of elements compared to those shown in FIG. 1 can be significantly minimized (to 2 elements per row, namely a microphone-speaker pair). In an aspect, the pair are centrally located in a row such that a single row vehicle has one microphone-speaker pair, a two row vehicle has two microphone-speaker pairs, a three row vehicle has three microphone-speaker pairs.

Note that though there are multiple speakers for a given direction, they are all driven with the same signal. Similarly, multiple microphones for a given direction may be summed or used to create a single beam in one desired direction.

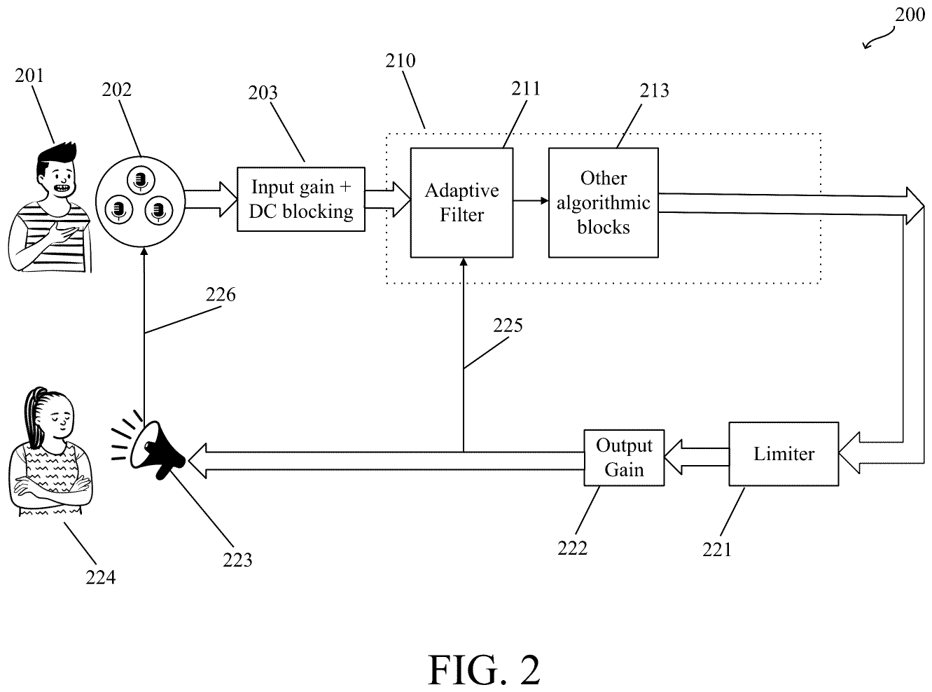

Referring to FIG. 2, an example of unidirectional in car communications (ICC) 200 is shown, in accordance with an exemplary aspect.

A microphone array 202 placed close to the talker 201 picks up the talker's 201 speech along with feedback 226 from the speaker 223 located at listener's 224 position.

DC blocking and input gain control 203 are applied to the signal comprising the talker's 201 speech along with the feedback 226.

An ICC portion 210 includes an adaptive filter 211. It may also include other algorithmic blocks 213 that are required to realize or enhance the working of ICC.

The adaptive filter 211 is used to suppress the feedback 226. The signal driving the speaker 223 needs to be provided as reference 225 to the adaptive filter 211.

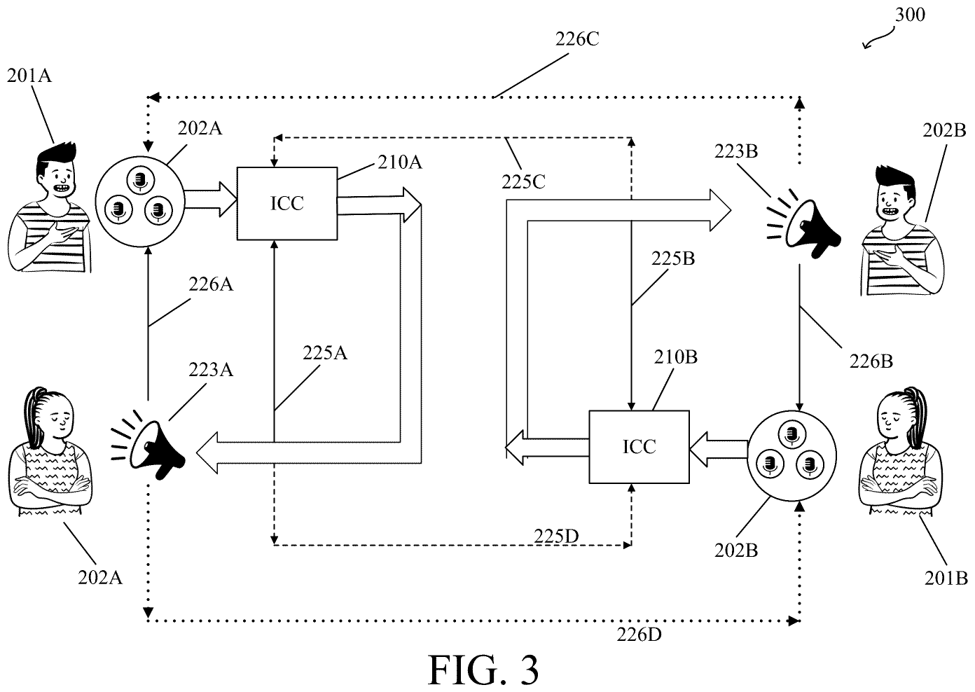

Referring to FIG. 3, an example of bidirectional in car communications (ICC) 300 is shown, in accordance with an exemplary aspect.

In bidirectional ICC 300, speakers 223A, 223B and microphones 202A, 202B are placed in both rows 151, 152. Hence the need for an additional ICC instance 210B (in additional to instance 210A). All signal processing blocks shown in previous slide are absorbed into the ICC instances 210A and 210B.

In bidirectional ICC 300, there are additional feedback paths 226C, 226D which are not present in unidirectional ICC 200. Hence each ICC instance 210A, 210B requires a second reference 225C, 225D to suppress the additional feedback component 226, 226D.

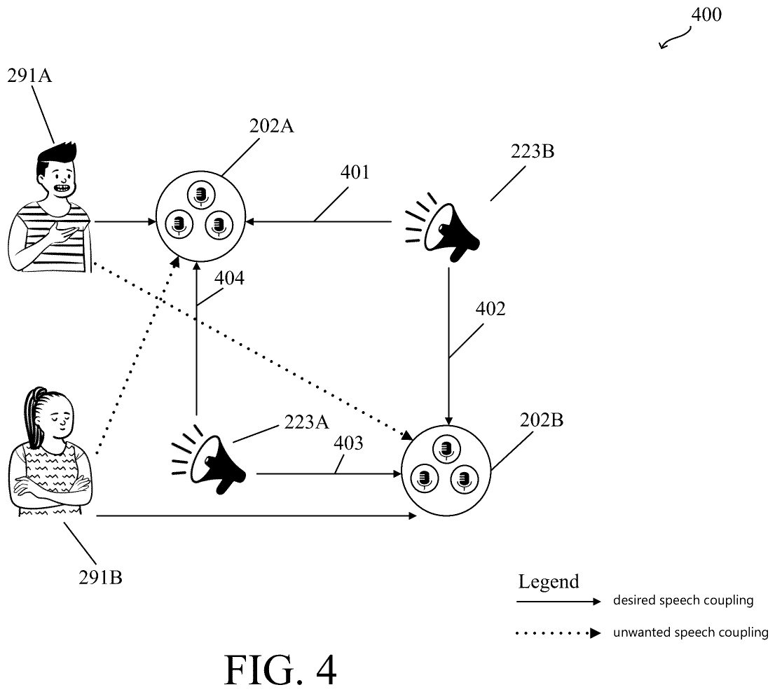

Referring to FIG. 4, another example of bidirectional in car communications (ICC) 400 is shown, in accordance with an exemplary aspect.

A problem is the need to continuously track multiple speaker to microphone paths, under continuous double talk condition. The number of paths increases as a product of number of speakers and microphones, so while it is just one path for unidirectional ICC, it is four paths 401, 402, 403, 404 for two row bidirectional ICC, nine for three row bidirectional ICC, and so on. Poor estimation of any of these paths can lead to artifacts.

A second problem that is observed in bidirectional communication, especially when established between adjacent rows in the vehicle, is that the microphone picks up speech originating from a row that it is not intended for (solid lines show desired speech paths and dotted lines show undesired speech paths). The result of this is that reinforced speech of the talker is rendered on the talker's own row in addition to the listener's row. This leads to the talker hearing an amplified version of his/her own voice, which can be perceived as unnatural and disturbing.

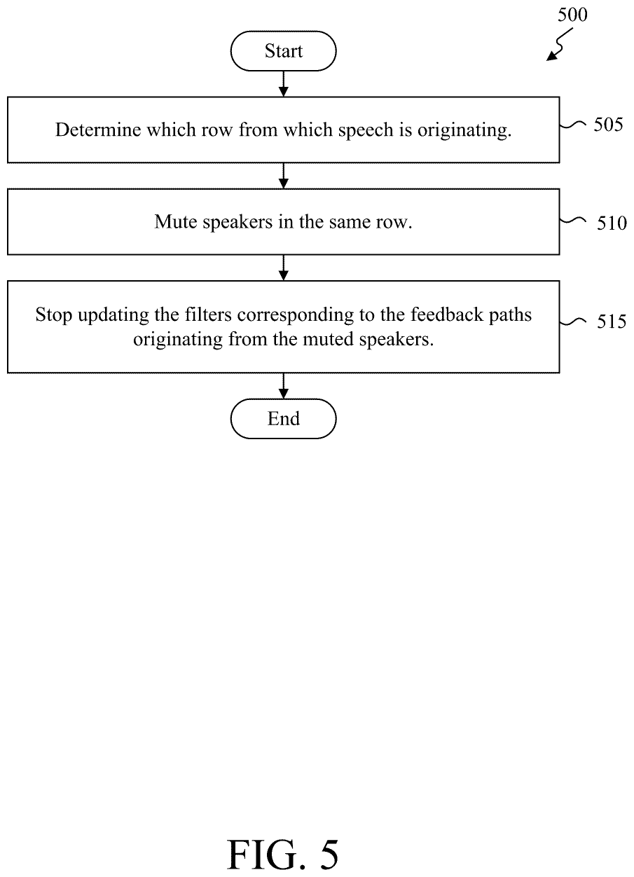

Referring to FIG. 5, an example method 500 for bidirectional in car communications (ICC) using cross-correlation is shown, in accordance with an exemplary aspect

At block 505, determine which row from which speech is originating.

At block 510, mute speakers in the same row.

At block 515, stop updating the filters corresponding to the feedback paths originating from the muted speakers. We do not mute microphones, as we must continuously monitor any changes in talker position.

As noted, the method 500 uses cross-correlation.

The method has the following advantages:

Method 500 requires only a single microphone per row in the vehicle, making it more cost effective. In comparison, the method described in prior-art uses 4 microphones per row.

Method 500 is more robust compared to beamforming. This is because the angular separation between two talkers seated, one-behind-the-other, in adjacent rows is small, making it difficult to design a beam that selectively attenuates one direction over the other. We find that the relative lag (which is measured by cross-correlation) is more reliable indicator of talker position.

The method has the following two limitations:

The time taken to switch ICC direction is in the order of ˜100 mS, but this is acceptable for ICC.

It cannot be distinguished between left and right positions on the same row, but this is not required in most cases.

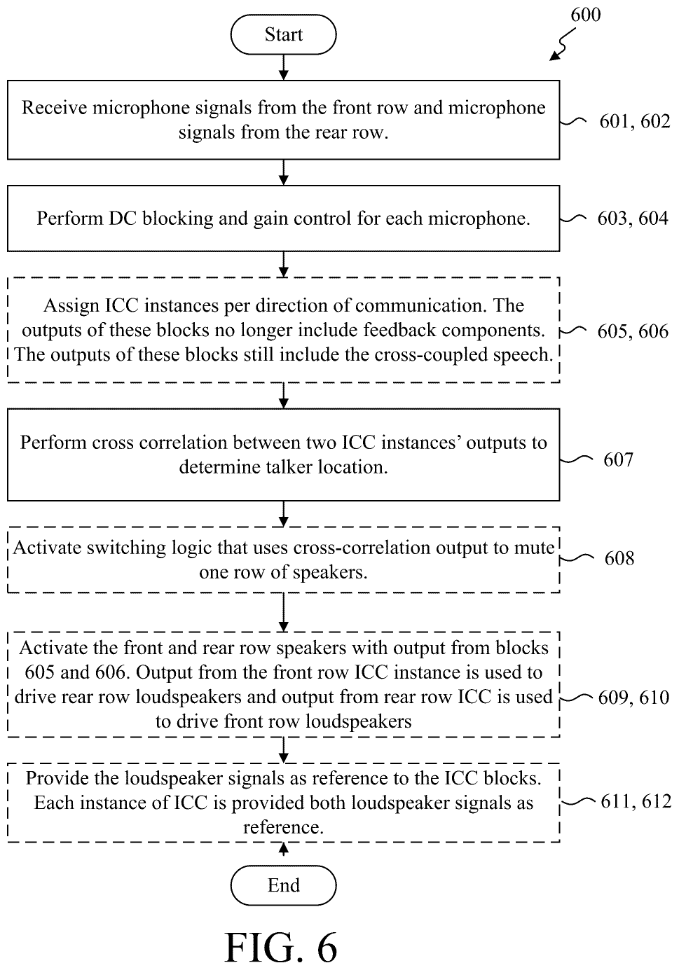

Referring to FIG. 6, another example method 600 for bidirectional in car communications (ICC) using cross-correlation is shown, in accordance with an exemplary aspect.

In an aspect, the number and arrangement of speakers and microphones in FIG. 1 may be used or some variation thereof. The following will be described with respect to FIG. 1. However, in another aspect, a single microphone-speaker pair per row is used to minimize the element of elements while achieving dynamic direction switching for bi-directional in car communication based on talker row identification.

At blocks 601 and 602, receive microphone signals from the front portion 151 and microphone signals from the rear portion 152. These include all the components shown in FIG. 4.

At blocks 603 and 604, perform DC blocking and gain control 203 for each microphone 111, 112, 113, 114.

At blocks 605 and 606, assign ICC instances 210A, 210B per direction of communication. The outputs of these blocks no longer include feedback components 226A, 226B, 226C, 226D. The outputs of these blocks still include the cross-coupled speech.

At block 607, perform cross correlation between two ICC instances' 210A, 210B outputs to determine talker 201A, 201B location.

At block 608, activate switching logic that uses cross-correlation output to mute one row of speakers.

At blocks 609 and 610, activate the front and rear row speakers with output from blocks 605 and 606. Output from the front row ICC instance is used to drive rear row loudspeakers and output from rear row ICC is used to drive front row loudspeakers.

At blocks 611 and 612, provide the loud speaker signals as reference to the ICC blocks. Each instance of ICC is provided both loudspeaker signals as reference.

A description will now be given relating to cross-correlation

Cross-correlation is computed in the frequency domain. Cross-correlation generates one lag value for each frame of input data. The raw lag estimate varies a lot, due to the non-stationary nature of speech signal. In an example aspect, the raw lag estimate is smoothed using a median filter of length 43. Other lengths can be used.

Wrong lag estimates can be generated during no-speech intervals. To avoid these wrong estimates from getting into the signal chain, lag estimates are ignored when either of the input signal energy falls below a threshold.

Another check performed on the lag estimate is to see if it falls within expected limits. The maximum limit is calculated from the microphone spacing in the vehicle.

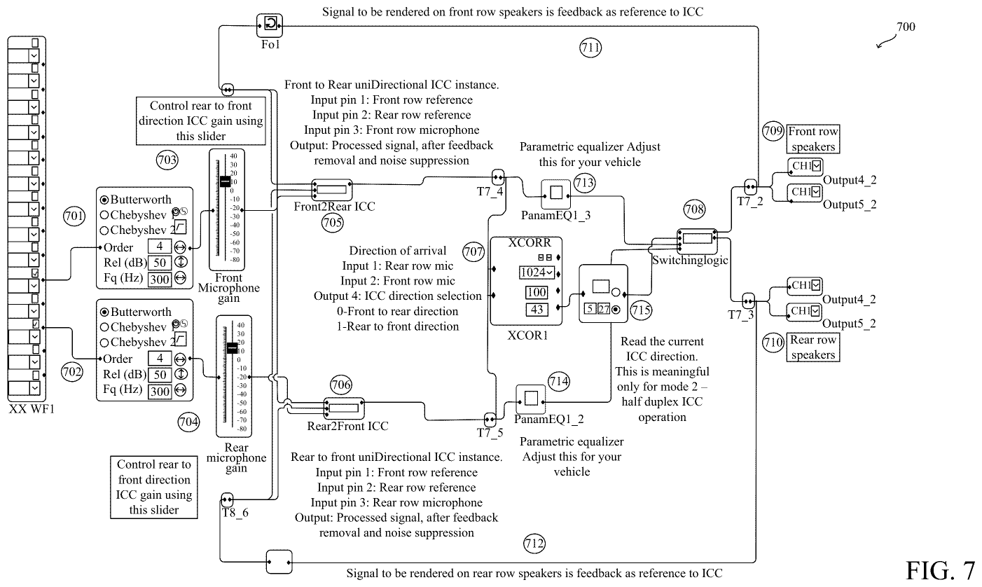

Referring to FIG. 7, a system 700 configured for bidirectional in car communications (ICC) using cross-correlation is shown, in accordance with an exemplary aspect. System 700 is similar to unidirectional ICC system 200 (FIG. 2), and bidirectional ICC systems 300 (FIG. 3) and 400 (FIG. 4) but extended to include the use of cross-correlation as first shown in system 700.

Acoustic signals are captured by a front seat row microphone 701 and a rear seat row microphone 702 in a vehicle such as a car although other vehicles can be used. The captured acoustic signals are processed by front seat row DC blocking and gain control portion 703 and rear seat row Direct Current (DC) blocking and gain control portion 704. In this context, “processed” refers to performing DC blocking and gain control on the captured acoustic signals. The front seat row DC blocking and gain control portion 703 and rear seat row DC blocking and gain control portion 704 respectively block Direct Current components in the captured acoustic signals and control microphone gain of the front seat row microphone 701 and the rear seat row microphone 702. The gain control is used by the end-user of the system to adjust loudness of the ICC system, in either direction.

The front seat row DC blocking and gain control portion 703 may include one or more of: one or more Butterworth filters; one or more Chebyshev filters; and so forth. The rear seat row DC blocking and gain control portion 704 may include one or more of: one or more Butterworth filters; one or more Chebyshev filters; one or more other type of DC blocking filter; and so forth.

One or more filters and/or filter types may be included in each of front seat row DC blocking and gain control portion 703 and rear seat row DC blocking and gain control portion 704. In an aspect, the type of filter is pre-selected (prior to a session of use).

ICC instance 705 and ICC instance 706 are respectively assigned per direction of communication. The directions of communication are based on which of the front seat row microphone 701 and rear seat row microphone 702 active, i.e., are capturing acoustic signals. Here, there can be front-to-back communication and back-to-front communication, that is, bidirectional ICC. In an aspect, the word “instance” refers to an algorithmic ICC instance generating block and not the generated signal.

The ICC instance 705 is a front seat row ICC instance generating algorithmic block including a front seat row adaptive filter 705A. The front seat row adaptive filter 705A is applied to the DC filtered acoustic signals from the front seat row DC blocking and gain control portion 703 to “clean” the DC filtered acoustic signals of unwanted feedback components to generate clean signals to render on the loudspeakers.

The ICC instance 706 is a rear seat row ICC instance generating algorithmic block including a rear seat row adaptive filter 706A. The rear seat row adaptive filter 706A is applied to the captured acoustic signals that have been DC filtered by the rear sear row DC blocking and gain control portion 704 to “clean” the DC filtered acoustic signals of unwanted feedback components to generate clean signals to render on the loudspeakers.

An adaptive filter estimates a function that maps a reference signal to the desired signal, by minimizing the mean squared error or some other cost function. Examples of adaptive filters are Normalized Least-Mean-Square (NLMS), Recursive Least-Square (RLS), and so forth.

Hence, the ICC instances 705 and 706 generate outputs that are “cleaned” and/or otherwise filtered to remove unwanted feedback components. In this way, cross-correlation can be performed between “clean” acoustic signals corresponding to the front seat row and “clean” acoustic signals corresponding to the rear seat row in a multi-seat-row (two or more seat rows) vehicle.

Inputs to the front seat row ICC instance 705 include the DC filtered acoustic signal to be rendered on the rear seat row speakers 710, a first reference signal being the loudspeaker signal to be rendered on the front seat row speakers 709, and a second reference signal being the loudspeaker signal to be rendered on the rear set row speakers 710. Outputs from the front seat row ICC instance 705 include the clean ICC signal after feedback removal and other algorithmic operations.

Inputs to the rear seat row ICC instance 706 include the DC filtered acoustic signal to be rendered on the front seat row speakers 709, a first reference signal being the loudspeaker signal to be rendered on the front seat row speakers 709, and a second reference signal being the loudspeaker signal to be rendered on the rear set row speakers 710. Outputs from the front seat row ICC instance 706 include the clean ICC signal after feedback removal and other algorithmic operations.

The loudspeaker signal to be rendered on the front seat row speakers 709 and the loudspeaker signal to be rendered on the rear set row speakers 710 are both provided as reference signals 711 and 712 to both ICC instance 705 and ICC instance 706. That is, each of the loudspeaker signal to be rendered on the front seat row speakers 709 and the loudspeaker signal to be rendered on the rear set row speakers 710 is provided to the ICC instance 705 and the ICC instance 706 as reference signals. In this way, a feedback signal can be measured or estimated and removed from the actual loudspeaker signals rendered on the front seat row speakers 709 and the rear set row speakers 710.

In an aspect, at least one raw lag value is generated for at least one audio data frame, and at least one raw lag value for at least one audio data frame is smoothed for use in speaker row identification. The lag value may be a measured and/or calculated value representing the difference between two time instants. In an aspect, one of the two time instants corresponds to an arrival time of speech at a set of microphones for a seat row and the other of the two instants corresponds to an arrival time of the speech at a set of microphones for a different seat row.

In an aspect, a neural network may be used to calculate the raw lag values from a set of input data corresponding to empirical and/or measured lag data for example corresponding to known similar in vehicle communication systems (e.g., systems having similar acoustic hardware (microphones and/or speakers) with similar positions (e.g., spacings) within the vehicle. In a neural network such as a supervised learning based neural network, lag values associated with specific acoustic hardware devices, transmission mediums (wires, fiber optic cable, wirelessly), and acoustic hardware layouts (e.g., positions of acoustic hardware components within a vehicle) may be used to compute the input data for the neural network. For example, at least one of the following items may be used to compute the input data for the neural network: (i) specific acoustic hardware data such as the make, model, year of manufacture, and operating characteristics of microphones and/or speakers located in the vehicle; (ii) various transmission delays of various transmission mediums used to convey the acoustic signals from the microphones to processing elements before being output by speakers such as wires, fiber optic cables, and/or wirelessly; and (iii) the spacings of the acoustic hardware devices within the vehicle. In an aspect, the spacings of the acoustic hardware devices are derived from locations of the acoustic hardware components within the vehicle. The neural network may be configured to reduce an error amount during a training or learning phase(s) in order to improve performance during non-training phases.

One or more lag values may be smoothed to avoid errors introduced from noise speech time segments or other fine-scale structures/rapid phenomena. In an aspect, a median filter may be used to smooth the one or more lag values. The data values are smoothed by creating an approximating function of the data values that attempts to capture important patterns in the data values, while leaving out noise or other fine-scale structures/rapid phenomena. In smoothing, the data points of a signal are modified so individual points higher than the adjacent points (presumably because of noise) are reduced, and points that are lower than the adjacent points are increased, leading to a smoother signal.

The cross-correlation block 707 performs cross-correlation. The cross-correlation block 707 may include one or more processors, operatively coupled to one or more memories, configured to perform cross-correlation. Cross-correlation is the process of comparing outputs from ICC instances 705 and 706 (that is, DC filtered as well as feedback filtered and optionally noise filtered acoustic signal instances) to each other so as to determine a seat row, from among the front seat row and the rear seat row, from which speech is originating from a loudest talker from among one or more talkers based on signal magnitude. Various features of the ICC instances 705 and 706 can be compared but preferably at least signal magnitude is compared to determine a seat row from a plurality of seat rows of a loudest talker from which speech is originating from a plurality of talkers as well as phase (lag) which indicates which row microphone captured the signal first, which implies that the talker is seated closer to that row microphone. The compared outputs from the ICC instances 705 and 706 are versions of the DC filtered acoustic signals from each of the front seat row microphone 701 and the rear seat row microphone 702 after removing unwanted feedback components. In an aspect, the phases and the magnitudes of the outputs from the ICC instances 705 and 706 are compared to determine a signal having a lowest lag value and/or a highest magnitude (or number of highest magnitudes, e.g., a highest average over a predetermined amount of time,) as corresponding to a seat row from which speech is originating from a loudest talker from among one or more talkers.

Responsive to a result of the cross-correlation block 707 (the identification of the seat row from which speech is originating from a loudest talker from among one or more talkers), the set of one or more loudspeakers 709 or 710 in the seat row of the loudest talker are muted by switching logic 708 and the operation is stopped of one or more ICC instances 705 or 706 (including their adaptive filters) on one or more of the acoustic signals corresponding to one or more feedback paths originating from the one or more loudspeakers 709 or 710 that are muted.

A communication path including ICC instance 705, in turn, includes a parametric equalizer 713. A communication path including ICC instance 706, in turn, includes a parametric equalizer 714. The parametric equalizers 713 and 714 are used to tune the characteristics (e.g., frequency contribution with respect to low-range (bass), mid-range, and/or high-range (treble)) of the sounds rendered on front seat row speakers 709 and the rear set row speakers 710 to a liking of the listener. Further, another function of the parametric equalizers 713 and 714 is to improve system stability by lowering the gain in frequency bands where the system has a tendency to howl, owing to the acoustic response of the cabin.

An ICC direction determination device 715 is configured to determine a current ICC direction along which to provide ICC communication. The current ICC direction is used to enable or disable any of the front seat row speakers 709 and/or the rear set row speakers 710, e.g., via switching logic 708

While shown with respect to a front seat row and a rear seat row, the present disclosure may be readily extended to apply to more than two seat rows. For example, more than two seat rows may be processed (compared) at once. In another example, more than two seat rows may be processed (compared) in pairs to find an ultimate winner, i.e., a seat row of a plurality of seat rows (e.g., a first seat row, a second seat row, a third seat row, and/or fourth seat row) from which speech is originating from a loudest talker from among one or more talkers.

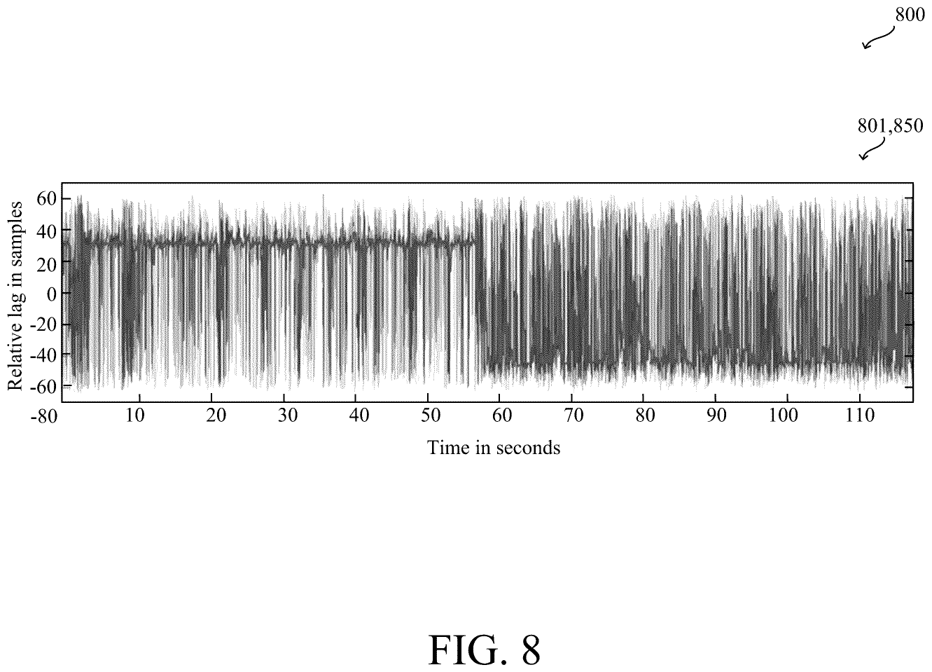

Referring to FIG. 8, a plot 801 of an unsmoothed lag cross-correlation estimate 800 and a smoothed cross-correlation estimate 850 is shown, in accordance with an exemplary aspect.

The plot 801 shows the time in seconds in the x-axis and the relative lag in samples in the y-axis. The unsmoothed lag cross-correlation estimate 800 is shown darker than the smoothed cross-correlation estimate 850.

Note that there are unusable estimates occurring during the pauses in speech. These are ignored using the two checks mentioned above.

Cross-correlation cannot be directly computed on the raw microphone signals. The presence of feedback components can cause the lag estimate to go wrong. Cross-correlation operates behind ICC.

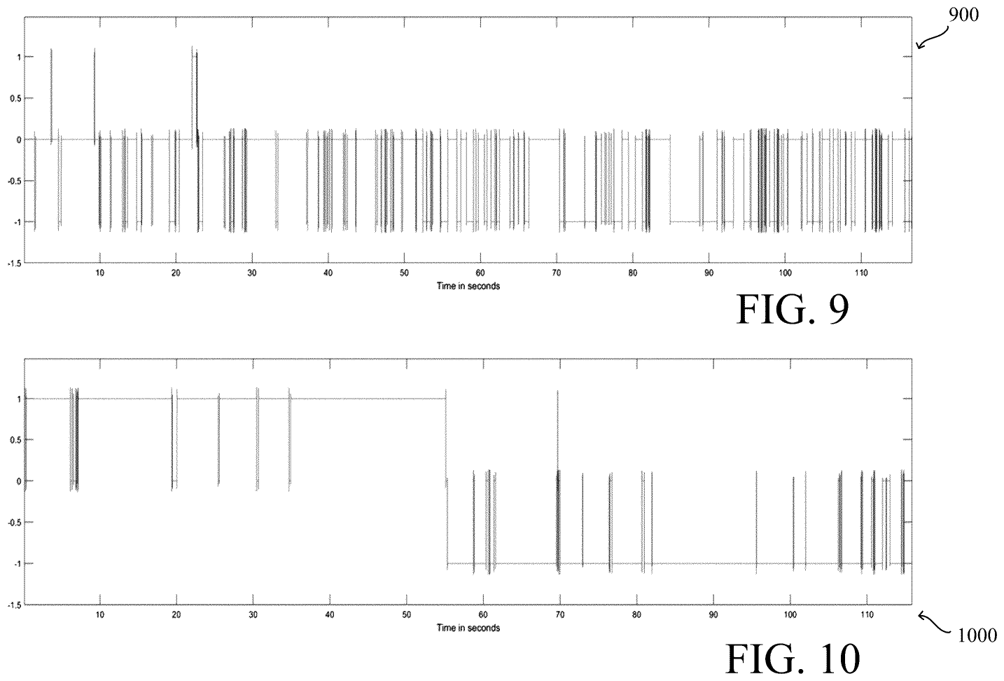

Referring to FIGS. 9 and 10, plots 900 and 1000 of the direction estimated using cross-correlation are respectively shown, in accordance with an exemplary aspect.

In the plots 900 and 1000, time in seconds is indicated in the x-axis and speech direction is indicated in the y-axis.

Regarding speech direction, a value of 1 corresponds to front row, a value of −1 corresponds to rear row, and a value of 0 corresponds to an inconclusive direction.

These values corresponds to a scenario where there is speech originating from the front row for first 55 seconds and then speech originating from the rear row for the remaining time.

When operated directly on the raw microphone signals (FIG. 9), the estimate is not usable but when operated in an ICC environment (FIG. 10) the estimate is close to ideal.

Thus, aspects of the present disclosure provide a method for talker position detection using cross correlation, in multi row bi-directional in car communication. As described above with respect to at least FIG. 7, talker position detection is performed by identifying a row from which speech is originating from a loudest talker from among a plurality of talkers. The identification is made on DC filtered acoustic signals that are further “cleaned” to remove unwanted feedback components. The identification is made by comparing respective “cleaned” speech signals in one or more directions to each other to identify a speech signal having a lowest lag value and/or a highest magnitude or highest number of magnitudes over a given time period, e.g., above a predetermined or dynamically variably threshold.

In an aspect, the method operates the cross correlation in an ICC environment. Thus, in vehicle communications can be cross-correlated to detect a row from which speech is originating from a loudest talker from among a plurality of talkers.

In an aspect, lag estimates are determined and median smoothing of the lag estimates is used to provide a stable position estimate. The stable position estimate is then used to detect a row from which speech is originating from a loudest talker from among a plurality of talkers in order to control various system components (e.g., any of speakers 709 and 710 and adaptive filters that are part of ICC instances 705 and 706).

In an aspect, the talker position information is used to mute the speakers 709 or 710 on the loudest talker's row. In this way, the talker does not hear an amplified version of the talker's own voice.

In an aspect, the talker position information is used to perform selective updating of adaptive filters. That is, operation is stopped of one or more adaptive filters that are part of ICC instances 705 or 706 on one or more of the speech signals corresponding to one or more feedback paths originating from the one or more loudspeakers 709 or 710 that are muted. In this way, incorrect filter updates using a zero or very low amplitude reference signals are prevented.

In an aspect, operation of bi-directional ICC can be performed in a half-duplex mode by the aid of above steps, thus reducing complexity and improving system stability.

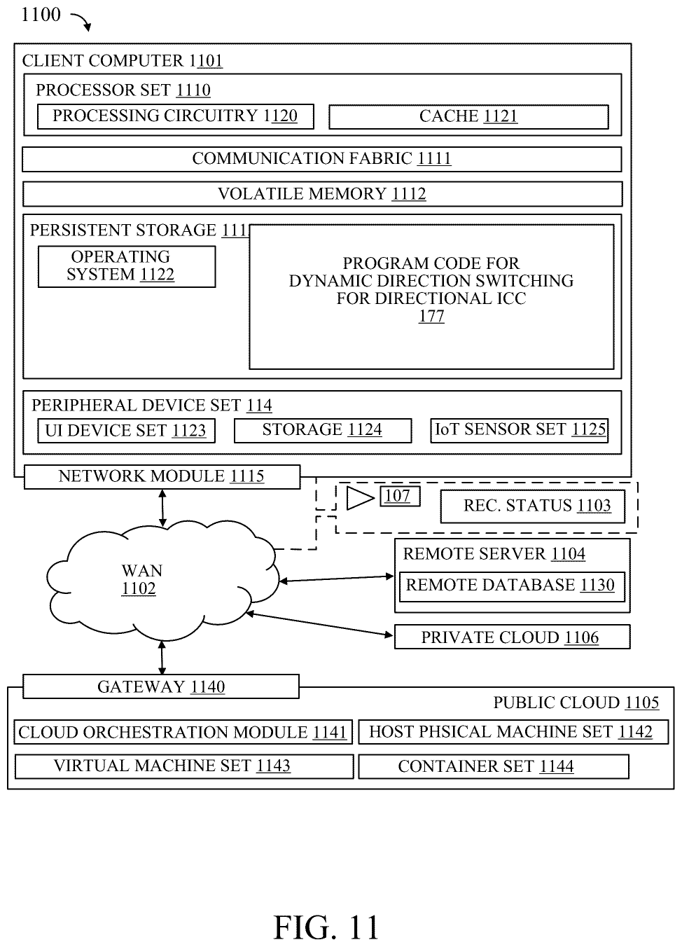

Referring to FIG. 11, an example computing environment 1100 is shown, in accordance with an aspect of the present disclosure. Computing environment may be an in-car computing system having microphones and speakers as described.

Computing environment 1100 includes an example of an environment including a client computer 1101 configured for the execution of at least some of the computer code 1177 involved in performing the methods described herein relating to dynamic direction switching for bidirectional in car communication (ICC) based on talker row identification. The one or more cameras 1107 may be integral with, or separate from, the client computer 1101. Moreover, the recording status indication 1103 may be a visual and/or audible, humanly-perceptible notification of whether or not the respective camera 1107 is recording. The computing environment 1100, in addition to computer code 1177, further includes for example, client computer 1101, wide area network (WAN) 1102, remote server 1104, public cloud 1105, and private cloud 1106. In this aspect, computer 1101 includes processor set 1110 (including processing circuitry 1120 and cache 1121), communication fabric 1111, volatile memory 1112, persistent storage 1113 (including operating system 1122 and block 177, as identified above), peripheral device set 1114 (including user interface (UI), device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

Computer 1101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. Alternatively, performance of the computer-implemented method(s) described herein may be distributed among multiple computers and/or between multiple locations. For the sake of simplicity, in this presentation of computing environment 1100, the following detailed discussion is focused on a single computer, specifically computer 1101. Computer 1101 may be located in a cloud, even though computer 1101 is not shown in a cloud in FIG. 11. On the other hand, computer 1101 is not required to be in a cloud except to any extent as may be affirmatively indicated. Computer 1101 may be interchangeably referred to herein as “voice user interface (VUI)-based device” 1101.

Processor set 1110 includes one or more computer processors of any type. Processing circuitry 1120 may be distributed over multiple packages, for example, multiple, coordinated integrated circuit chips. Processing circuitry 1120 may implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set may be located “off chip.” In some computing environments, processor set 1110 may be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, at least some of the instructions for performing the inventive methods may be stored in computer code 1177 in persistent storage 1113.

Communication fabric 1111 is the signal conduction paths that allow the various components of computer 1101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 1112 is any type of volatile memory now known or to be developed in the future. Examples include dynamic type random access memory (RAM) or static type RAM. Typically, the volatile memory is characterized by random access, but this is not required unless affirmatively indicated. In computer 1101, the volatile memory 1112 is located in a single package and is internal to computer 1101, but, alternatively or additionally, the volatile memory may be distributed over multiple packages and/or located externally with respect to computer 1101. Relating to an online aspect, volatile memory 1112 may include a first buffer 1112A for collecting input samples and a second buffer 1112B for outputting the processed audio.

Persistent storage 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 may be a read only memory (ROM), but typically at least a portion of the persistent storage allows writing of data, deletion of data and re-writing of data. Some familiar forms of persistent storage include magnetic disks and solid state storage devices. Operating system 1122 may take several forms, such as various known proprietary operating systems or open source Portable Operating System Interface type operating systems that employ a kernel. The code included in computer code 1177 typically includes at least some of the computer code involved in performing the inventive methods.

Peripheral device set 1114 includes the set of peripheral devices of computer 1101. Data communication connections between the peripheral devices and the other components of computer 1101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various aspects, UI device set 1123 may include components such as one or more of a display screen, speaker or speaker array, microphone or microphone array, wearable devices (such as goggles and smart watches), keyboard, mouse, printer, touchpad, virtual reality goggles, augmented reality goggles, mixed reality goggles, game controllers, a voice user interface (VUI), an automatic speech recognition system (ASR), a text-to-speech (TTS) system, cameras, and haptic devices. Storage 1124 is external storage, such as an external hard drive, or insertable storage, such as an SD card. Storage 1124 may be persistent and/or volatile. In some aspects, storage 1124 may take the form of a quantum computing storage device for storing data in the form of qubits. In aspects where computer 1101 is required to have a large amount of storage (for example, where computer 1101 locally stores and manages a large database) then this storage may be provided by peripheral storage devices designed for storing very large amounts of data, such as a storage area network (SAN) that is shared by multiple, geographically distributed computers. IoT sensor set 1125 is made up of one or more sensors that can be used in Internet of Things applications. For example, one sensor may be a thermometer and another sensor may be a motion detector.

Further regarding peripheral device set 1114, the same is emphasized to include a set of cameras. In an aspect, the cameras are CCTV cameras. In an aspect, the cameras are doorbell cameras. In an aspect, the cameras are body-worn cameras. It is to be appreciated that the aspects of the present disclosure can be applied to any type of camera for which a human would be interested in knowing whether or not they are being recorded.

Network module 1115 is the collection of computer software, hardware, and firmware that allows computer 1101 to communicate with other computers through WAN 1102. Network module 1115 may include hardware, such as modems or Wi-Fi signal transceivers, software for packetizing and/or de-packetizing data for communication network transmission, and/or web browser software for communicating data over the internet. In some aspects, network control functions and network forwarding functions of network module 1115 are performed on the same physical hardware device. In other aspects (for example, aspects that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some aspects, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

Remote server 1104 is any computer system that serves at least some data and/or functionality to computer 1101. Remote server 1104 may be controlled and used by the same entity that operates computer 1101. Remote server 1104 represents the machine(s) that collect and store helpful and useful data for use by other computers, such as computer 1101.

Public cloud 1105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs may be stored as images and may be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware, and firmware that allows public cloud 1105 to communicate through WAN 1102.

Public cloud 1105 may provide a subscription service for people interaction to a plurality of users such as a user of computer 1101. The service can have multiple purposes for people interaction. Such purposes for people interaction can include dating, friendship, and business.

In an aspect, public cloud 1105 operates in conjunction with remote server 1104 to enable profile information of users to be retrieved and provided to a user such as one using computer 1101 and/or another user operating a similar device as computer 1101.

Private cloud 1106 is similar to public cloud 1105, except that the computing resources are only available for use by a single enterprise. While private cloud 1106 is depicted as being in communication with WAN 1102, in other aspects a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this aspect, public cloud 1105 and private cloud 1106 are both part of a larger hybrid cloud.

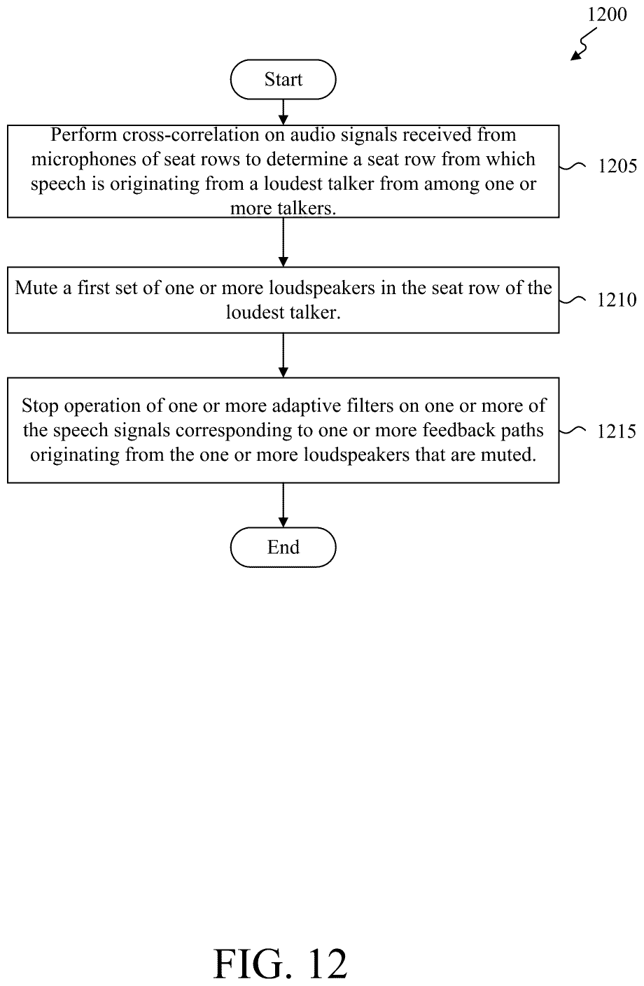

Referring to FIG. 12, an in-vehicle communication method 1200 is shown, in accordance with an exemplary aspect. In the Figures, solid lines for the method blocks denote required steps while dashed and/or dotted blocks denote optional steps and/or sub-steps. In an aspect, in-vehicle communication method 1200 is performed by communication system 700 of FIG. 7.

At block 1205, the method 1200 includes performing, by a cross-correlation block 707 having one or more processors operatively coupled to one or more memories, cross-correlation on audio signals received from a plurality of microphones in a plurality of seat rows of a vehicle to determine a seat row of the plurality of seat rows from which speech is originating from a loudest talker from among one or more talkers. In an aspect, the cross-correlation is computed by the cross-correlation block 707 in the frequency domain. In an aspect, the cross-correlation is computed from “clean” audio signals 705, 706 (processed to remove unwanted components) obtained the raw (unprocessed) acoustic signals 701, 702 captured by the plurality of microphones. In an aspect, the clean audio signals are obtained by removing unwanted feedback components from the raw acoustic signals. The unwanted components are removed from the raw acoustic signals by filtering out the feedback component from the raw acoustic signals using an adaptive filter 705A, 706A that includes, e.g., NLMS, RLS and/or other type of adaptive filter.

In an aspect, the clean audio signals are correlated to find the relative lag (e.g., each of the clean audio signals corresponding to a respective row in the vehicle and being clean by being free of unwanted speech and non-speech sound components). In an aspect, the clean audio signal having the lowest lag value and/or the highest amplitude is designated as originating from the seat row of the plurality of seat rows from which speech is originating from a loudest talker from among one or more talkers.

At block 1210, the method 1200 includes muting, by a parametric equalizer 713 or 714 coupled to the cross-correlation block 707, a first set of one or more loudspeakers in the seat row of the loudest talker. In an aspect, muting is achieved by powering down the first set of one or more loudspeakers 709 or 710. In an aspect, muting is achieved by placing the first set of one or more loudspeakers 709 or 710 in a “mute” mode where sound is not reproduced by the one or more loudspeakers 709 or 710.

At block 1215, the method 1200 includes stopping operation of one or more adaptive filters 705A or 706A on one or more of the speech signals corresponding to one or more feedback paths originating from the one or more loudspeakers that are muted. In an aspect, stopping operation is achieved by stopping filter updating of respective ones of the adaptive filters 705A or 706A assigned to the one or more speech signals corresponding to the one or more feedback paths originating from the one or more loudspeakers 709 or 710 that are muted. In an aspect, stopping operation is achieved by bypassing respective ones of the adaptive filters assigned to the one or more speech signals corresponding to the one or more feedback paths originating from the one or more loudspeakers 709 or 710 that are muted.

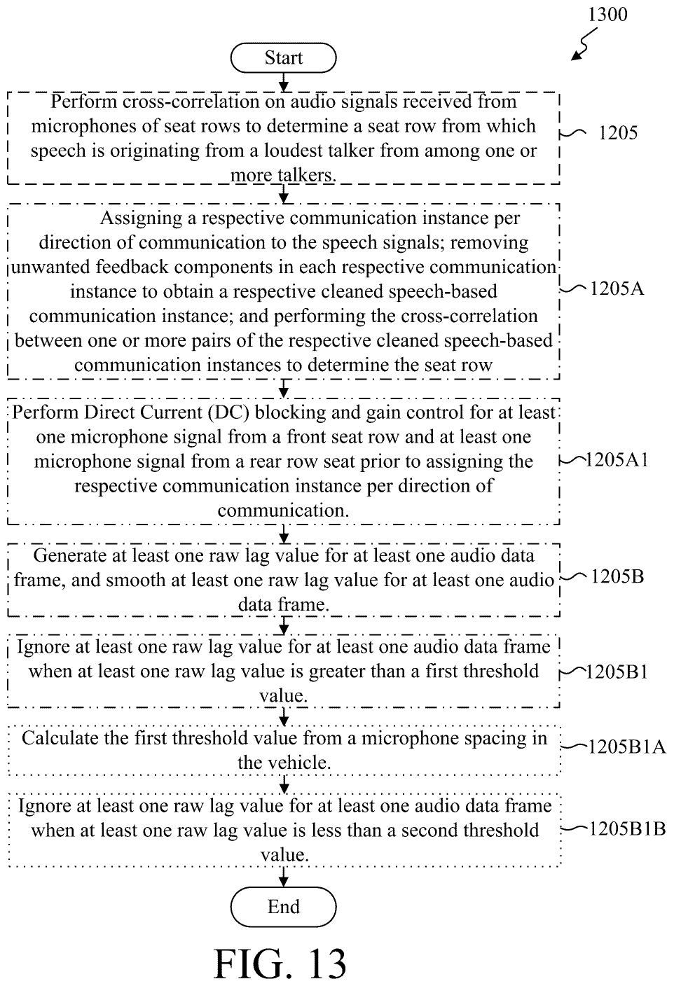

Referring to FIG. 13, further blocks of block 1205 are shown, in accordance with an exemplary aspect.

In an aspect, block 1205 may include one or more of blocks 1205A and blocks 1205B.

At block 1205A, the method 1200 includes assigning a respective communication instance per direction of communication to the speech signals, removing unwanted feedback components in each respective communication instance to obtain a respective cleaned speech-based communication instance 705 and 706, and performing the cross-correlation between one or more pairs of the respective cleaned speech-based communication instances 705 and 706 to determine the seat row.

In an aspect, block 1205A may include block 1205A1.

At block 1205A1, the method 1200 includes performing Direct Current (DC) blocking and gain control 703, 704 for at least one microphone signal from a front seat row and at least one microphone signal from a rear row seat prior to assigning the respective communication instance per direction of communication.

At block 1205B, the method 1200 includes generating at least one raw lag value for at least one audio data frame, and smoothing the at least one raw lag value for the at least one audio data frame. In an aspect, the at least one raw lag value is generated by the cross-correlation block 707.

The lag value may be a measured and/or calculated value representing the difference between two time instants. In an aspect, one of the two time instants corresponds to an arrival time of speech at a set of microphones for a seat row and the other of the two instants corresponds to an arrival time of the speech at a set of microphones for a different seat row.

In an aspect, a neural network in and/or coupled to the adaptive filters 705A and 706A may be used to calculate the raw lag values from a set of input data corresponding to empirical and/or measured lag data for example corresponding to known similar in vehicle communication systems (e.g., systems having similar acoustic hardware (microphones and/or speakers) with similar positions (e.g., spacings) within the vehicle. In a neural network such as a supervised learning based neural network, lag values associated with specific acoustic hardware devices, transmission mediums (wires, fiber optic cable, wirelessly), and acoustic hardware layouts (e.g., positions of acoustic hardware components within a vehicle) may be used to compute the input data for the neural network. For example, at least one of the following items may be used to compute the input data for the neural network: (i) specific acoustic hardware data such as the make, model, year of manufacture, and operating characteristics of microphones and/or speakers located in the vehicle; (ii) various transmission delays of various transmission mediums used to convey the acoustic signals from the microphones to processing elements before being output by speakers such as wires, fiber optic cables, and/or wirelessly; and (iii) the spacings of the acoustic hardware devices within the vehicle. In an aspect, the spacings of the acoustic hardware devices are derived from locations of the acoustic hardware components within the vehicle. The neural network may be configured to reduce an error amount during a training or learning phase(s) in order to improve performance during non-training phases.

One or more lag values may be smoothed to avoid errors introduced from noise speech time segments. In an aspect, a median filter may be used to smooth the one or more lag values. The data values are smoothed by creating an approximating function of the data values that attempts to capture important patterns in the data values, while leaving out noise or other fine-scale structures/rapid phenomena.

In an aspect, block 1205B may include block 1205B1.

At block 1205B1, the method 1200 includes ignoring the at least one raw lag value for the at least one audio data frame when the at least one raw lag value is greater than a first threshold value. In an aspect, “ignoring” means ceasing from further consideration including not smoothing an ignored value. In an aspect, “ignoring” means discarding and/or otherwise deleting from an ignored value from a memory device.

In an aspect, block 1205B1 may include one or more of block 1205B1A and 1205B1B.

At block 1205B1A, the method 1200 includes calculating the first threshold value from a microphone spacing in the vehicle.

At block 1205B1B, the method 1200 includes ignoring the at least one raw lag value for the at least one audio data frame when the at least one raw lag value is less than a second threshold value. In an aspect, “ignoring” means ceasing from further consideration including not smoothing an ignored value. In an aspect, “ignoring” means discarding and/or otherwise deleting from an ignored value from a memory device.

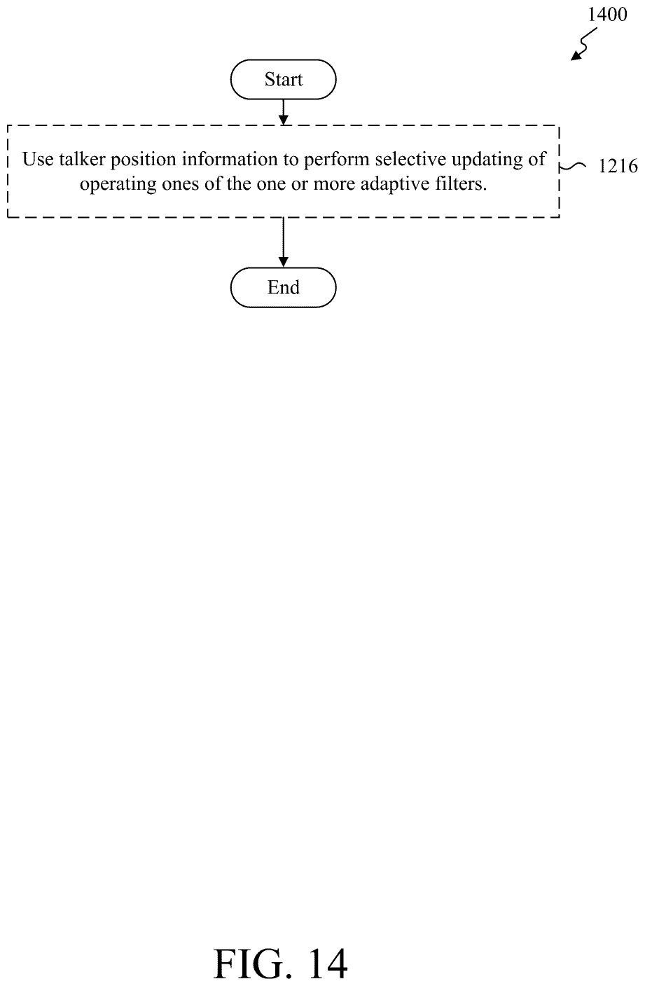

Referring to FIG. 14, further blocks of the method 1200 of FIG. 12 are shown, in accordance with an exemplary aspect.

In an aspect, the method 1200 may include block 1216.

At block 1216, the method 1200 includes using talker position information to perform selective updating of operating ones of the one or more adaptive filters.

The present disclosure is to be considered in view of the following clauses.

Clause 1. A method of in-vehicle communication, comprising: performing cross-correlation on audio signals received from a plurality of microphones in a plurality of seat rows of a vehicle to determine a seat row of the plurality of seat rows from which speech is originating from a loudest talker from among one or more talkers; muting a first set of one or more loudspeakers in the seat row of the loudest talker; and stopping operation of one or more adaptive filters on one or more of the speech signals corresponding to one or more feedback paths originating from the one or more loudspeakers that are muted.

Clause 2. The method in accordance with clause 1, wherein the plurality of microphones in the plurality of seat rows comprises a single microphone in each of the plurality of seat rows.

Clause 3. The method in accordance with any preceding clauses, wherein the plurality of microphones in the plurality of seat rows consists of a single microphone in each of the plurality of seat rows.

Clause 4. The method in accordance with any preceding clauses, wherein the single microphone in each of the plurality of seat rows is paired with a single loudspeaker in each of the plurality of seat rows.

Clause 5. The method in accordance with any preceding clauses, wherein performing cross-correlation on the audio signals comprises: assigning a respective communication instance per direction of communication to the speech signals; removing one or more unwanted feedback components in each respective communication instance to obtain a respective cleaned speech-based communication instance; and performing the cross-correlation between one or more pairs of the respective cleaned speech-based communication instances to determine the seat row.

Clause 6. The method in accordance with any preceding clauses, wherein the one or more unwanted speech and non-speech sound components comprise a feedback component.

Clause 7. The method in accordance with any preceding clauses, wherein the one or more unwanted non-speech sound components comprise a noise component.

Clause 8. The method in accordance with any preceding clauses, further comprising performing Direct Current (DC) blocking and gain control for at least one microphone signal from a front seat row and at least one microphone signal from a rear row seat prior to assigning the respective communication instance per direction of communication.

Clause 9. The method in accordance with any preceding clauses, wherein the cross-correlation is computed in a frequency domain.

Clause 10. The method in accordance with any preceding clauses, wherein performing cross-correlation on the audio signals comprises: generating at least one raw lag value for at least one audio data frame; and smoothing the at least one raw lag value for the at least one audio data frame.

Clause 11. The method in accordance with any preceding clauses, further comprising ignoring the at least one raw lag value for the at least one audio data frame when the at least one raw lag value is greater than a first threshold value.

Clause 12. The method in accordance with any preceding clauses, wherein the first threshold value is calculated from a microphone spacing in the vehicle.

Clause 13. The method in accordance with any preceding clauses, further comprising ignoring the at least one raw lag value for the at least one audio data frame when the at least one raw lag value is less than a second threshold value.

Clause 14. The method in accordance with any preceding clauses, further comprising using talker position information to perform selective updating of operating ones of the one or more adaptive filters.

Clause 15. An apparatus, comprising: one or more memories; one or more processors coupled with the one or more memories, wherein the one or more processors are configured, individually or in combination, to: perform cross-correlation on audio signals received from a plurality of microphones in a plurality of seat rows of a vehicle to determine a seat row of the plurality of seat rows from which speech is originating from a loudest talker from among one or more talkers; mute a first set of one or more loudspeakers in the seat row of the loudest talker; and stop operation of one or more adaptive filters on one or more of the speech signals corresponding to one or more feedback paths originating from the one or more loudspeakers that are muted.

Clause 16. The apparatus in accordance with clause 15, wherein the plurality of microphones in the plurality of seat rows comprises a single microphone in each of the plurality of seat rows.

Clause 17. The apparatus in accordance with any preceding clauses, wherein the plurality of microphones in the plurality of seat rows consists of a single microphone in each of the plurality of seat rows.

Clause 18. The apparatus in accordance with any preceding clauses, wherein the single microphone in each of the plurality of seat rows is paired with a single loudspeaker in each of the plurality of seat rows.

Clause 19. The apparatus in accordance with any preceding clauses, wherein performing cross-correlation on the audio signals comprises: assigning a respective communication instance per direction of communication to the speech signals; removing one or more unwanted non-speech sound components in each respective communication instance to obtain a respective cleaned speech-based communication instance; and performing the cross-correlation between one or more pairs of the respective cleaned speech-based communication instances to determine the seat row.

Clause 20. The apparatus in accordance with any preceding clauses, wherein the one or more unwanted non-speech sound components comprise a feedback component.

Clause 21. The apparatus in accordance with any preceding clauses, wherein the one or more unwanted non-speech sound components comprise a noise component.

Clause 22. The apparatus in accordance with any preceding clauses, further comprising performing Direct Current (DC) blocking and gain control for at least one microphone signal from a front seat row and at least one microphone signal from a rear row seat prior to assigning the respective communication instance per direction of communication.

Clause 23. The apparatus in accordance with any preceding clauses, wherein the cross-correlation is computed in a frequency domain.

Clause 24. The apparatus in accordance with any preceding clauses, wherein performing cross-correlation on the audio signals comprises: generating at least one raw lag value for at least one audio data frame; and smoothing the at least one raw lag value for the at least one audio data frame.

Clause 25. The apparatus in accordance with any preceding clauses, further comprising ignoring the at least one raw lag value for the at least one audio data frame when the at least one raw lag value is greater than a first threshold value.

Clause 26. The apparatus in accordance with any preceding clauses, wherein the first threshold value is calculated from a microphone spacing in the vehicle.

Clause 27. The apparatus in accordance with any preceding clauses, further comprising ignoring the at least one raw lag value for the at least one audio data frame when the at least one raw lag value is less than a second threshold value.

Clause 28. The apparatus in accordance with any preceding clauses, further comprising using talker position information to perform selective updating of operating ones of the one or more adaptive filters.

Clause 29. A computer-readable medium having instructions stored thereon, wherein the instructions are executable by one or more processors, individually or in combination, to perform a method comprising steps of: performing cross-correlation on audio signals received from a plurality of microphones in a plurality of seat rows of a vehicle to determine a seat row of the plurality of seat rows from which speech is originating from a loudest talker from among one or more talkers; muting a first set of one or more loudspeakers in the seat row of the loudest talker; and stopping operation of one or more adaptive filters on one or more of the speech signals corresponding to one or more feedback paths originating from the one or more loudspeakers that are muted.

Various aspects of the disclosure may take the form of an entirely or partially hardware aspect, an entirely or partially software aspect, or a combination of software and hardware. Furthermore, as described herein, various aspects of the disclosure (e.g., systems and methods) may take the form of a computer program product comprising a computer-readable non-transitory storage medium having computer-accessible instructions (e.g., computer-readable and/or computer-executable instructions) such as computer software, encoded or otherwise embodied in such storage medium. Those instructions can be read or otherwise accessed and executed by one or more processors to perform or permit the performance of the operations described herein. The instructions can be provided in any suitable form, such as source code, compiled code, interpreted code, executable code, static code, dynamic code, assembler code, combinations of the foregoing, and the like. Any suitable computer-readable non-transitory storage medium may be utilized to form the computer program product. For instance, the computer-readable medium may include any tangible non-transitory medium for storing information in a form readable or otherwise accessible by one or more computers or processor(s) functionally coupled thereto. Non-transitory storage media can include read-only memory (ROM); random access memory (RAM); magnetic disk storage media; optical storage media; flash memory, and so forth.

Aspects of this disclosure are described herein with reference to block diagrams and flowchart illustrations of methods, systems, apparatuses, and computer program products. It can be understood that each block of the block diagrams and flowchart illustrations, and combinations of blocks in the block diagrams and flowchart illustrations, respectively, can be implemented by computer-accessible instructions. In certain implementations, the computer-accessible instructions may be loaded or otherwise incorporated into a general-purpose computer, a special-purpose computer, or another programmable information processing apparatus to produce a particular machine, such that the operations or functions specified in the flowchart block or blocks can be implemented in response to execution at the computer or processing apparatus.

Unless otherwise expressly stated, it is in no way intended that any device protocol, procedure, process, or method set forth herein be construed as requiring that its acts or steps be performed in a specific order. Accordingly, where a process or method claim does not actually recite an order to be followed by its acts or steps, or it is not otherwise specifically recited in the claims or descriptions of the subject disclosure that the steps are to be limited to a specific order, it is in no way intended that an order be inferred, in any respect. This holds for any possible non-express basis for interpretation, including: matters of logic with respect to the arrangement of steps or operational flow; plain meaning derived from grammatical organization or punctuation; the number or type of aspects described in the specification or annexed drawings; or the like.

As used in this disclosure, including the annexed drawings, the terms “component,” “module,” “system,” and the like are intended to refer to a computer-related entity or an entity related to an apparatus with one or more specific functionalities. The entity can be either hardware, a combination of hardware and software, software, or software in execution. One or more of such entities are also referred to as “functional elements.” As an example, a component can be a process running on a processor, a processor, an object, an executable, a thread of execution, a program, and/or a computer. For example, both an application running on a server or network controller, and the server or network controller can be a component. One or more components can reside within a process and/or thread of execution and a component can be localized on one computer and/or distributed between two or more computers. Also, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which parts can be controlled or otherwise operated by program code executed by a processor. As yet another example, a component can be an apparatus that provides specific functionality through electronic components without mechanical parts, the electronic components can include a processor to execute program code that provides, at least partially, the functionality of the electronic components. As still another example, interface(s) can include I/O components or Application Programming Interface (API) components. While the foregoing examples are directed to aspects of a component, the exemplified aspects or features also apply to a system, module, and similar.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in this specification and annexed drawings should be construed to mean “one or more” unless specified otherwise or clear from context to be directed to a singular form.

In addition, the terms “example” and “such as” and “e.g.” are utilized herein to mean serving as an instance or illustration. Any aspect or design described herein as an “example” or referred to in connection with a “such as” clause or “e.g.” is not necessarily to be construed as preferred or advantageous over other aspects or designs described herein. Rather, use of the terms “example” or “such as” or “e.g.” is intended to present concepts in a concrete fashion. The terms “first,” “second,” “third,” and so forth, as used in the claims and description, unless otherwise clear by context, is for clarity only and does not necessarily indicate or imply any order in time or space.

The term “processor,” as utilized in this disclosure, can refer to any computing processing unit or device comprising processing circuitry that can operate on data and/or signaling. A computing processing unit or device can include, for example, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can include an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. In some cases, processors can exploit nano-scale architectures, such as molecular and quantum-dot based transistors, switches and gates, in order to optimize space usage or enhance performance of user equipment. A processor may also be implemented as a combination of computing processing units.

In addition, terms such as “store,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory. Moreover, a memory component can be removable or affixed to a functional element (e.g., device, server).

Simply as an illustration, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Various aspects described herein can be implemented as a method, apparatus, or article of manufacture using special programming as described herein. In addition, various of the aspects disclosed herein also can be implemented by means of program modules or other types of computer program instructions specially configured as described herein and stored in a memory device and executed individually or in combination by one or more processors, or other combination of hardware and software, or hardware and firmware. Such specially configured program modules or computer program instructions, as described herein, can be loaded onto a general-purpose computer, a special-purpose computer, or another type of programmable data processing apparatus to produce a machine, such that the instructions which execute on the computer or other programmable data processing apparatus create a means for implementing the functionality of disclosed herein.

The term “article of manufacture” as used herein is intended to encompass a computer program accessible from any non-transitory computer-readable device, carrier, or media. For example, computer readable media can include but are not limited to magnetic storage devices (e.g., hard drive disk, floppy disk, magnetic strips, or similar), optical discs (e.g., compact disc (CD), digital versatile disc (DVD), blu-ray disc (BD), or similar), smart cards, and flash memory devices (e.g., card, stick, key drive, or similar).

The detailed description set forth herein in connection with the annexed figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well-known components are shown in block diagram form, while some blocks may be representative of one or more well-known components.

The previous description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A method of in-vehicle communication, comprising:
performing cross-correlation on audio signals received from a plurality of microphones in a plurality of seat rows of a vehicle to determine a seat row of the plurality of seat rows from which speech is originating from a loudest talker from among one or more talkers;
muting a first set of one or more loudspeakers in the seat row of the loudest talker; and
stopping operation of one or more adaptive filters on one or more of the speech signals corresponding to one or more feedback paths originating from the one or more loudspeakers that are muted.

2. The method in accordance with claim 1, wherein the plurality of microphones in the plurality of seat rows comprises a single microphone in each of the plurality of seat rows.

3. The method in accordance with claim 1, wherein the plurality of microphones in the plurality of seat rows consists of a single microphone in each of the plurality of seat rows.

4. The method in accordance with claim 3, wherein the single microphone in each of the plurality of seat rows is paired with a single loudspeaker in each of the plurality of seat rows.

5. The method in accordance with claim 1,
wherein performing cross-correlation on the audio signals comprises:
assigning a respective communication instance per direction of communication to the speech signals;
removing unwanted feedback components in each respective communication instance to obtain a respective cleaned speech-based communication instance; and
performing the cross-correlation between one or more pairs of the respective cleaned speech-based communication instances to determine the seat row.

6. The method in accordance with claim 5, further comprising performing Direct Current (DC) blocking and gain control for at least one microphone signal from a front seat row and at least one microphone signal from a rear row seat prior to assigning the respective communication instance per direction of communication.

7. The method in accordance with claim 1, wherein the cross-correlation is computed in a frequency domain.

8. The method in accordance with claim 1, wherein performing cross-correlation on the audio signals comprises generating at least one raw lag value for at least one audio data frame.

9. The method in accordance with claim 8, further comprising ignoring the at least one raw lag value for the at least one audio data frame when the at least one raw lag value is greater than a first threshold value.

10. The method in accordance with claim 9, wherein the first threshold value is calculated from a microphone spacing in the vehicle.

11. The method in accordance with claim 9, further comprising ignoring the at least one raw lag value for the at least one audio data frame when the at least one raw lag value is less than a second threshold value.

12. The method in accordance with claim 1, further comprising using talker position information to perform selective updating of operating ones of the one or more adaptive filters.

13. An apparatus, comprising:
one or more memories;
one or more processors coupled with the one or more memories, wherein the one or more processors are configured, individually or in combination, to:
perform cross-correlation on audio signals received from a plurality of microphones in a plurality of seat rows of a vehicle to determine a seat row of the plurality of seat rows from which speech is originating from a loudest talker from among one or more talkers;
mute a first set of one or more loudspeakers in the seat row of the loudest talker; and
stop operation of one or more adaptive filters on one or more of the speech signals corresponding to one or more feedback paths originating from the one or more loudspeakers that are muted.

14. The apparatus in accordance with claim 13, wherein the plurality of microphones in the plurality of seat rows comprises a single microphone in each of the plurality of seat rows.

15. The apparatus in accordance with claim 14, wherein the plurality of microphones in the plurality of seat rows consists of a single microphone in each of the plurality of seat rows.

16. The apparatus in accordance with claim 15, wherein the single microphone in each of the plurality of seat rows is paired with a single loudspeaker in each of the plurality of seat rows.

17. The apparatus in accordance with claim 13,
wherein performing cross-correlation on the audio signals comprises:
assigning a respective communication instance per direction of communication to the speech signals;
removing unwanted feedback components in each respective communication instance to obtain a respective cleaned speech-based communication instance; and
performing the cross-correlation between one or more pairs of the respective cleaned speech-based communication instances to determine the seat row.

18. The apparatus in accordance with claim 17, further comprising performing Direct Current (DC) blocking and gain control for at least one microphone signal from a front seat row and at least one microphone signal from a rear row seat prior to assigning the respective communication instance per direction of communication.

19. The apparatus in accordance with claim 13, wherein the cross-correlation is computed in a frequency domain.

20. A computer-readable medium having instructions stored thereon, wherein the instructions are executable by one or more processors, individually or in combination, to perform a method comprising steps of:
performing cross-correlation on audio signals received from a plurality of microphones in a plurality of seat rows of a vehicle to determine a seat row of the plurality of seat rows from which speech is originating from a loudest talker from among one or more talkers;
muting a first set of one or more loudspeakers in the seat row of the loudest talker; and
stopping operation of one or more adaptive filters on one or more of the speech signals corresponding to one or more feedback paths originating from the one or more loudspeakers that are muted.
